(19) United States
(12) Patent Application Publication
(10) Pub. No.: US 2024/0386572 A1
(43) Pub. Date: Nov. 21, 2024

(54) INTERACTIVE 3D SEGMENTATION

(71) Applicant: Covidien LP, Mansfield, MA (US)

(72) Inventors: Ofer Barasofsky, Tel Mond (IL); Ariel Birenbaum, Raanana (IL)

(73) Assignee: Covidien LP, Mansfield, MA (US)

(21) Appl. No.: 18/569,886

(22) PCT Filed: Jul. 20, 2022
(86) PCT No.: PCT/US2022/037710

§ 371 Date: Dec. 13, 2023

Related U.S. Application Data
(60) Provisional application No. 63/224,265, filed on Jul. 21, 2021.
(60) Provisional application No. 63/256,218, filed on Oct. 15, 2021.

(51) Int. Cl. G06T 7/11

(52) U.S. Cl. CPC G06T 7/11; G06T 2207/10081; G06T 2207/20084; G06T 2207/20092; G06T 2207/30061

(57) ABSTRACT

A system includes a processor and a memory. The memory stores a neural network, which when executed by the processor automatically segments structures in computed tomography images of an anatomical structure, receives an indication of errors within the automatic segmentation, updates parameters of the neural network based upon the indicated errors, and updates the segmentation based upon the updated parameters of the neural network.

### CROSS-REFERENCE TO RELATED APPLICATION

This application claims the benefit of, and priority to, U.S. Provisional Patent Application Ser. No. 63/224,265, filed on Jul. 21, 2021, and U.S. Provisional Patent Application Ser. No. 63/256,218, filed on Oct. 15, 2021, the entire content of each of which is hereby incorporated by reference herein.

### BACKGROUND

### Technical Field

The present disclosure relates to the field of developing three-dimensional anatomic models based on medical imaging, and in particular, automatic segmentation of three-dimensional anatomic models using neural networks and interactive user feedback to train the neural network.

### Description of Related Art

In many domains there is a need for segmenting structures within volumetric data. In terms of medical imaging, there are many open source and proprietary systems that enable manual segmentation and/or classification of medical images such as computed tomography (CT) images. These systems typically require a clinician or a medical support technician to manually review the CT images to select the structure within the CT images for segmentation.

Automatic segmentation techniques typically isolate entire structures. As can be appreciated, the segmentation requirements may differ from one procedure to another. In this manner, a clinician performing a biopsy may be interested in segmenting only the solid part of the lesion, whereas a clinician interested in completely removing the lesion may want to segment the non-solid ground glass opacity originating from the lesion.

In practice, a clinician may be required to correct inaccuracies in the segmentation or add or remove portions of the lesion to be segmented depending upon the procedure being performed. As can be appreciated, much time can be consumed correcting or updating the segmentation and the process can be tedious as it needs to be completed during surgical planning before each surgical procedure.

### SUMMARY

In accordance with the present disclosure, a system includes a processor and a memory. The memory stores a neural network, which when executed by the processor, automatically segments structures in computed tomography (CT) images of an anatomical structure, receives an indication of errors within the automatic segmentation, updates parameters of the neural network based upon the indicated errors, and updates the segmentation based upon the updated parameters of the neural network.

In aspects, the CT images of an anatomical structure may be CT images of a lung.

In other aspects, the indicated errors within the automatic segmentation may be portions of the anatomical structure which should be included in the segmentation.

In certain aspects, the indicated errors within the automatic segmentation may be portions of the anatomical structure which should not be included in the segmentation.

In other aspects, the updated segmentation may be non-local.

In aspects, updating the parameters of the neural network may include updating only a portion of the parameters of the neural network.

In certain aspects, when the processor executes the neural network, the neural network may identify the type or surgical procedure being performed.

In other aspects, the type of surgical procedure being performed may be selected from the group consisting of a biopsy of a lesion, a wedge resection of the lungs, a lobectomy of the lungs, a segmentectomy of the lungs, and a pneumonectomy of the lungs.

In aspects, the system may include a display associated with the processor and the memory, wherein the neural network, when executed by the processor, displays the automatic segmentation in a user interface.

In accordance with another aspect of the present disclosure, a method include acquiring image data of an anatomical structure, acquiring information on an area of interest located within image data of the anatomical structure, automatically segmenting the area of interest from the image data using a neural network, receiving information of errors within the automatic segmentation, updating parameters of the neural network based upon the errors within the automatic segmentation, and updating the segmentation based upon the updated parameters of the neural network.

In aspects, acquiring image data may include acquiring computed tomography (CT) image data of the anatomical structure.

In other aspects, receiving information of errors within the automatic segmentation may include receiving information of portions of the anatomical structure which should not be included in the segmentation.

In certain aspects, receiving information of errors within the automatic segmentation may include receiving information of portions of the anatomical structure which should be included in the segmentation.

In other aspects, updating parameters of the neural network may include updating only a portion of the parameters of the neural network.

In accordance with yet another aspect of the present disclosure, a method includes acquiring computed tomography (CT) image data of an anatomical structure, automatically segmenting an area of interest from the CT image data using a neural network, receiving information of errors within the automatic segmentation, updating a portion of the parameters of the neural network based upon the errors within the automatic segmentation, updating the segmentation based upon the updated parameters of the neural network, receiving information of further errors within the updated segmentation, further updating a portion of the updated parameters of the neural network based upon the further errors within the updated segmentation, and further updating the updated segmentation based upon the further updated parameters of the neural network.

In aspects, acquiring CT image data of an anatomical structure may include acquiring CT image data of the lungs.

In other aspects, receiving information of errors within the automatic segmentation may include receiving information of portions of the anatomical structure which should not be included in the segmentation.

In certain aspects, receiving information of errors within the automatic segmentation may include receiving information of portions of the anatomical structure which should be included in the segmentation.

In other aspects, the method may include displaying the automatic segmentation on a user interface of a display.

In aspects, the method may include receiving information of the type of surgical procedure being performed and updating the parameters of the neural network based upon the type of surgical procedure being performed.

### BRIEF DESCRIPTION OF THE DRAWINGS

Various aspects and embodiments of the disclosure are described hereinbelow with references to the drawings, wherein:

FIG. 1 is a block diagram illustrating a portion of the surgical system provided in accordance with the present disclosure;

FIG. 2 is a one illustration of a user interface of the system of FIG. 1, displaying a CT image including a portion of a patient's lungs displaying lung disease;

FIG. 3 is another illustration of the user interface of FIG. 2, displaying a user selecting an area of interest displayed in the CT image;

FIG. 4 is still another illustration of the user interface of FIG. 2, displaying an initial segmentation of the selected area of interest;

FIG. 5 is yet another illustration of the user interface of FIG. 2, displaying a user annotating a portion of the CT image that should be included in the segmentation;

FIG. 6 is another illustration of the user interface of FIG. 2, displaying a user annotating a portion of the CT image that should not be included in the segmentation;

FIG. 7 is yet another illustration of the user interface of FIG. 2, displaying an updated segmentation based upon the user input;

FIG. 8 is another illustration of the user interface of FIG. 2, displaying a 3D mesh of the segmentation of the area of interest;

FIG. 9 is an illustration of the user interface of FIG. 2, displaying an initial segmentation and an automatic, updated segmentation based upon machine learning;

FIG. 10 is another illustration of the user interface of FIG. 2, displaying an initial segmentation and an automatic updated segmentation based upon further machine learning;

FIG. 11 is still another illustration of the user interface of FIG. 2, displaying an initial segmentation and an automatic updated segmentation based upon even further machine learning; and

FIG. 12 is a flow diagram illustrating a method in accordance with aspects of the present disclosure.

### DETAILED DESCRIPTION

This disclosure is directed to improved techniques and methods of automatically segmenting lesions from three-dimensional (3D) models of anatomical structures using deep learning (e.g., machine learning) and correcting the segmentation using interactive user feedback in the form of annotations of inaccurate segmentation points located inside and outside the original automatic segmentation. In this manner, the user input is used to quickly and efficiently retrain parts of the deep network (e.g., neural network) and minimally adjust the network weights to accommodate the user feedback in a minimal amount of time (e.g., a few seconds). The result of this user input is a non-local change in the segmentation that can quickly generate accurate and adjusted for a specific use case segmentation. It is envisioned that these systems and methods can be utilized for any segmentation model without the need to retain the model or change any inputs thereto. Additionally, training the deep network provides for more accurate segmentation for each use-case (e.g., biopsy, resection, etc.), thereby reducing the amount of time a clinician must correct or otherwise modify the automatic segmentation.

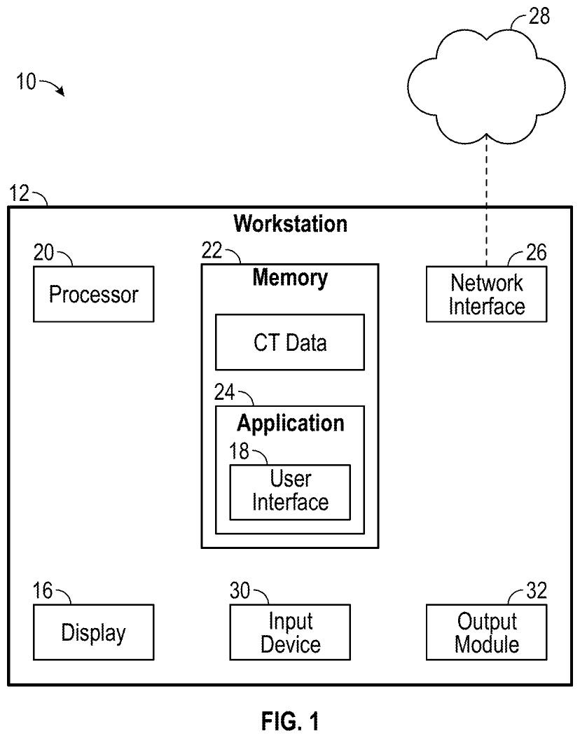

Turning now to the drawings, a system for automatically segmenting lesions from 3D models of anatomical structures is illustrated in FIG. 1 and generally identified by reference numeral 10. The system includes a workstation 12 having a computer 14 and a display 16 that is configured to display one or more user interfaces 18. The workstation 12 may be a desktop computer or a tower configuration with the display 16 or may be a laptop computer or other computing device (e.g., tablet, smartphone, etc.). The workstation 12 includes a processor 20 which executes software stored in a memory 22. The memory 22 may store video or other imaging data captured in real-time or pre-procedure images from, for example a computed-tomography (CT) scan, Positron Emission Tomography (PET), Magnetic Resonance Imaging (MRI), Cone-beam CT), amongst others. In addition, the memory 22 may store one or more applications 24 to be executed by the processor 20. Though not explicitly illustrated, the display 16 may be incorporated into a head mounted display such as an augmented reality (AR) headset such as the HoloLens offered by Microsoft Corp.

A network interface 26 enables the workstation 12 to communicate with a variety of other devices and systems via the Internet or Intranet. The network interface 26 may connect the workstation 12 to the Internet via an ad-hoc Bluetooth® or wireless networks enabling communication with a wide-area network (WAN) and/or local area network (LAN). The network interface 26 may connect to the Internet via one or more gateways, routers, and network address translation (NAT) devices. The network interface 26 may communicate with a cloud storage system 28, in which further image data and videos may be stored. The cloud storage system 28 may be remote from the premises of the hospital such as in a control or hospital information technology room. An input device 30 receives inputs from an input device such as a keyboard, a mouse, voice commands, amongst others. An output module 32 connects the processor 20 and the memory 22 to a variety of output devices, such as the display 16. It is envisioned that the output module 32 may include any connectivity port or bus, such as, for example, parallel ports, serial ports, universal serial busses (USB), or any other similar connectivity port known to those skilled in the art. In embodiments, the workstation 12 may include its own display, which may be a touchscreen display.

In embodiments, the network interface 26 may couple the workstation 12 to a Hospital Information System (HIS) to enable the review of patient information. As such, the workstation 12 includes a synthesizer which communicates with the HIS either directly or through a cloud computing network via a hardwired connection or wirelessly. Information accessible by the system includes information stored on a Picture Archiving and Communication System (PACS), a Radiology Information System (RIS), an Electronic Medical Records System (EMR), a Laboratory Information System (LIS), and in embodiments, a Cost and Inventory System (CIS), wherein each of which communicates with the HIS. Although generally described as utilizing the HIS, it is envisioned that the patient information may be obtained from any other suitable source, such as private office, compact-disc (CD) or other storage medium, etc.

The system 10 includes a Patient/Surgeon Interface System or Synthesizer which enables communication with the HIS and its associated databased. Using information gathered from the HIS, an Area of Interest (AOI) is able to be identified illustrating the effects of lung disease, and in embodiments, the software application associated with the synthesizer may be able to automatically identify areas of interest and present these identified areas to a clinician for review via the user interface 18. Image data gathered from the HIS is processed by the software application to generate a three-dimensional (3D) reconstruction of the patient's lungs, and using medical information gathered from the HIS, such as, for example, prior surgical procedures, diagnosis of common lung conditions such as Chronic Pulmonary Obstruction Disorder (COPD), and the location of common structures within the patient's body cavity, the software application generates a 3D model of the patient's lungs incorporating this information.

The user interface 18 enables a clinician to create, store, and/or select unique profiles in the memory 22 associated with the clinician performing the procedure or the procedure being performed. As can be appreciated, each clinician may have different standards or preferences as to how accurate a segmentation must be, and likewise, different procedures may require a different segmentation. Specifically, a clinician performing a biopsy may prefer a different segmentation to a clinician performing a lobectomy. In this manner, the clinician may create a profile using the user interface 18 and store the profile in the memory 22 or using the network interface 26 coupled to the HIS, cloud storage system 28, amongst others. In this manner, the pre-trained neural network model may be associated with the profile such that training of the neural network can be tailored for the specific profile.

Using the generated 3D model and the information gathered from the HIS, the clinician must identify whether the lesion has penetrated lobes, segments, blood vessels, or the like and must determine the lesion size, shape, position, and its boundaries. To accurately determine each of these attributes, the AOI must be segmented or otherwise separated from the surrounding tissue and/or structures within the 3D model of the patient's lungs. As can be appreciated, manually segmenting thee structures from the 3D model can be tedious and time consuming. The software application stored in the memory 22 may automatically, or may be used to manually, segment the AOI from the 3D model and determine the type or procedure that is required to remove the AOI (e.g., wedge resection, lobectomy, pneumonectomy, segmentectomy, etc.). To this end, it is contemplated that the software application stored on the memory 22 may identify if the AOI or lesion has penetrated a lobe or lobes of the patient's lungs, segments, blood vessels, amongst others. Additionally, the software application determines the size of the lesion, the shape of the lesion, the position of the lesion, and the boundaries of the lesion. Although generally described as being directed to resection of portions of the lung, it is contemplated that the systems and methods described herein may be utilized for many surgical procedures, such as biopsies, etc., and for surgical procedures directed to other anatomical structures, such as the liver, the heart, the spleen, etc.

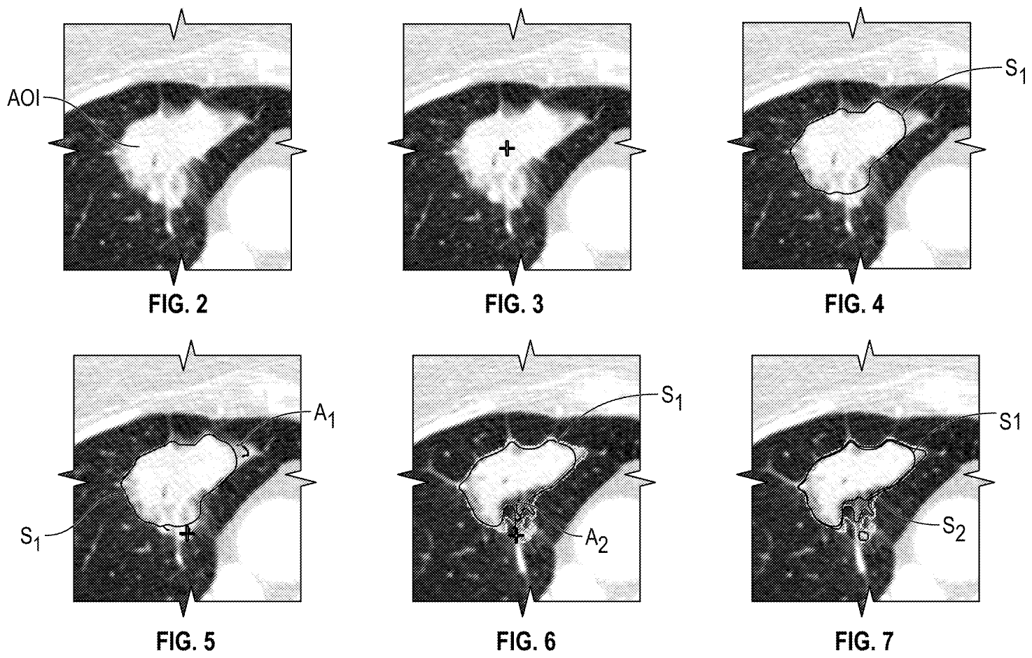

Utilizing the software application, an image containing a lesion is identified in the CT data and displayed on the user interface 18 (FIG. 2). The software application enables the clinician to identify a structure within an image patch of pre-procedure CT data, which is then input into a pre-trained neural network model (FIG. 3). Thereafter, the pre-trained neural network model segments the identified structure from the CT data and presents an initial segmentation “S₁” on the user interface 18 (FIG. 4). As described hereinabove, it is envisioned that the pre-trained neural network model may be associated with a type or procedure being performed or a particular clinician. As can be appreciated, a biopsy procedure may require a different segmentation than a resection procedure, and similarly, one clinician may prefer a different segmentation to another. In this manner, the software application segments the identified structure from the CT data based upon the type of pre-trained neural network model that is selected.

As can be appreciated, the pre-trained neural network model may output an inaccurate segmentation, in which case the segmentation includes portions of the structure that should not be part of the segmentation or omits portions of the structure that should be part of the segmentation. To correct the segmentation, the clinician may manually annotate the segmentation to identify portions of the structure that should be part of the segmentation “A₁” (FIG. 5), or alternatively, manually annotates the segmentation to identify portions of the structure that should not be part of the segmentation “A₂” (FIG. 6). It is envisioned that the annotation may be points, lines, circles, amongst others and may differ in color, shape, size, etc. depending on whether the portion of the segmentation is to be included or removed from the updated segmentation.

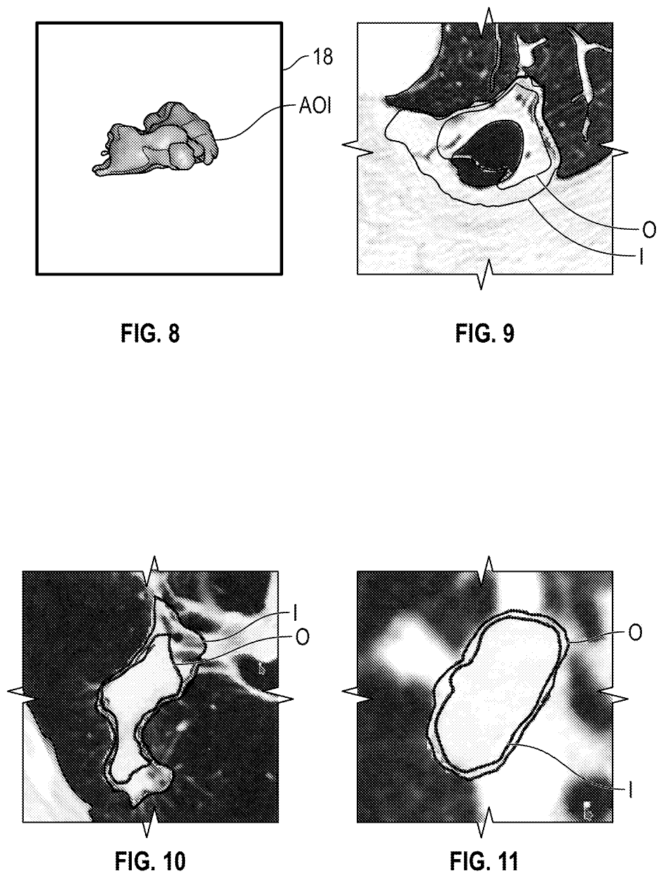

Once the annotation is completed, the neural network is updated to incorporate the user provided annotation and develop an updated segmentation “S₂” that is global in nature, in that additional structures, other than those selected by the user, are included or excluded in the updated segmentation (FIG. 7). The inaccuracies may be as a result of the updated segmentation or the original segmentation. The clinician may continue to mark portions of the structure inside and outside of the segmentation to include or remove structure from the segmentation until the clinician is satisfied with the accuracy of the segmentation. In this manner, the neural network is continually updating its input and learning or otherwise improving the segmentation based upon the user inputs, such that other area of interest or lesions selected during the same session are more accurately segmented, or if the updated neural network is saved in a profile or other manner, may provide a more accurate initial segmentation, thereby requiring less user input to obtain the desired segmentation. As can be appreciated, the more the neural network is utilized and updated, the more accurate future segmentations become. In this manner, it is envisioned that the clinician may save the updated neural network to a profile associated with the clinician, or to a particular type of procedure, such as a biopsy, lobectomy, segmentectomy, etc. Once the segmentation is determined to be accurate, the software application generates a 3D mesh or model of the lesion and presents the 3D mesh of the lesion on the user interface 18 (FIG. 8). In embodiments, the 3D mesh or model of the lesion is updated after each update to the segmentation. In this manner, as the segmentation is updated after each annotation, the 3D mesh or model is likewise updated and in embodiments is concurrently displayed to the user along with the updated segmentation.

Although generally described as utilizing a 3D model, 3D model generation is not necessarily required in the implementation of the systems and methods described herein. As can be appreciated, the systems and methods described herein utilize a segmentation, which separates images into separate objects. In the case of the segmentation of the patient's lungs, the purpose of the segmentation is to separate the objects that make up the airways and the vasculature (e.g., the luminal structures) from the surrounding lung tissue. Those of skill in the art will understand that while generally described in conjunction with CT image data (e.g., a series of slice images that make up a 3D volume), the instant disclosure is not so limited and may be implemented in a variety of imaging techniques including MRI, fluoroscopy, X-Ray, ultrasound, PET, and other imaging techniques that generate 3D image volumes without departing from the scope of the present disclosure. Additionally, those of skill in the art will recognize that a variety of different algorithms may be employed to segment the CT image data set, including connected component, region growing, thresholding, clustering, watershed segmentation, edge detection, amongst others.

The neural network utilizes an initial equation of y=Fₙₑₜ(x;p) where x is the patch, p is the network parameters of the neural network model, and y is the segmentation that is output from the model. By modifying the network parameters p, an updated segmentation y′ is output. A difference between segmentations y and y′ is calculated using the equation L=y′−y. The process of updating the network parameters p is repeated until the difference between the two segmentations L is minimized (e.g., the original and updated segmentations are generally identical). It is envisioned that L may be minimized using backwards propagation of gradients.

In embodiments, a deep neural network may be used in the systems and methods of this disclosure where only specific weights (e.g., parameters) of the neural network are updated using the equation L=αL₁+βL₂ where α is 1 and β is 10. L₁ is represented by the equation

$$max {L}_{1} = \{ \begin{matrix}max \{ 1 - {y}_{i} \} , & i ∈ inside \\ max \{ {y}_{i} , \} , & i ∈ outside\end{matrix}$$

and L₂ is represented by L₂=∥p−p′∥. The process is repeated until L₁<0.5.

It is envisioned that the systems and methods described herein may be utilized with any pre-trained neural network model and in embodiments, may not require re-training of the pre-trained model and may not change the pre-trained network input. Additionally, the systems and methods herein require minimal time to accomplish a converged solution, which do not require multiple forward passes for the entire neural network model and update only a few gradients without requiring full model backward propagation. In embodiments, the amount of time required to segment the image data and generate a mesh is less than 1 second, and the mesh size is between 100 and 600 KB, and the accuracy of the segmentation is approximately ½ spacing per axis. As can be appreciated, the systems and methods described herein result in non-local changes to the segmentation, in that changes in one area of the segmentation affect other areas of the segmentation. It is envisioned that the systems and methods described herein may be optimized by adding a new layer to the neural network and to update only the weights and may be modified to include different loss/optimizer. In embodiments, the systems and methods described herein may also be utilized to improve segmentation of blood vessels and the like.

With reference to FIGS. 9-11, three examples of improving the pre-trained neural network are illustrated. FIG. 9 illustrated the original automatic segmentation “O” within the interactive, improved segmentation “I”. FIG. 10 illustrates the original automatic segmentation “O” within the interactive, improved segmentation “I”, where the original automatic segmentation “O” is significantly closer to the interactive, improved segmentation “I” based upon the neural network learning from previous inputs and annotations provided by the user. FIG. 11 illustrates the original automatic segmentation “O” outside of the interactive, improved segmentation “I”, where the original automatic segmentation “O” is almost identical to the interactive improved segmentation “I” based upon continued neural network learning from previous inputs and annotations provided by the user. In embodiments, the neural network model may be trained by having the neural network model provide partial results when segmenting an image. The partial results are then used by the neural network model to automatically identify a particular structure within the image and the parameters of the algorithm are then updated based upon the results provided by the neural network model. In this manner, the neural network model is able to improve the accuracy of the algorithm without receiving input from a clinician.

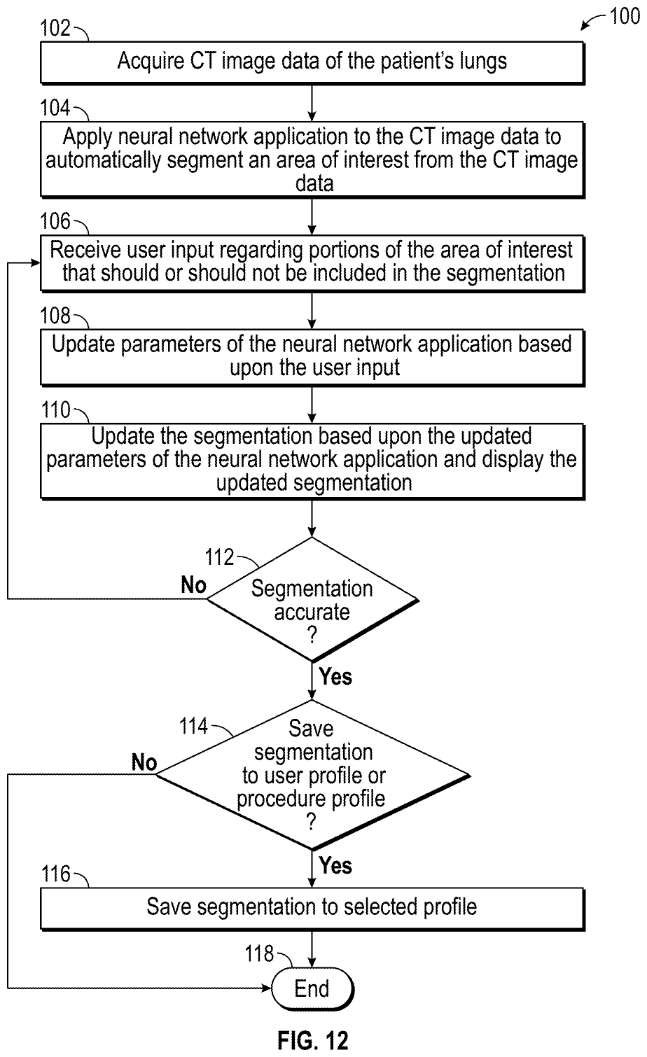

With reference to FIG. 12, a method of automatically segmenting lesions from three-dimensional (3D) models of anatomical structures using deep learning (e.g., machine learning) and correcting the segmentation using interactive user feedback in the form of annotations of inaccurate segmentation points is illustrated and generally identified by reference numeral 100. Initially, in step 102, CT image data of the patient's lungs is acquired (e.g., from the HIS, etc.). In step 104, the processor 20 executes a software application stored on the memory 22 to apply an algorithm associated with a pre-trained neural network to the acquired CT image data to automatically segment an area of interest (e.g., a lesion) from the acquired CT image data. In embodiments, the pre-trained neural network may be associated with a profile selected by the clinician, such as a profile associated with a particular clinician or a particular surgical procedure, or combinations thereof. In step 106, the clinician annotates the automatic segmentation to identify portions of the area of interest that should or should not be included in the segmentation. Thereafter, in step 108, the parameters of the neural network algorithm are updated based upon the annotations made by the user. The software application updates the segmentation based upon the updated parameters of the neural network algorithm and displays the updated segmentation to the clinician in step 110. In step 112, the clinician reviews the updated segmentation and determines if further annotations and/or revisions are needed or if the segmentation is accurate. If further annotations and/or revisions are needed, the process returns to step 106 to further annotate and update the segmentation. If the updated segmentation is accurate, in step 114, the clinician may save the segmentation to a specific user profile or associate the segmentation with a particular procedure in order to be utilized in a future procedure. If the clinician opts to save the segmentation, the segmentation is saved in the memory 22 as being associated with the user profile or procedure in step 116 and the process ends at step 118. Alternatively, if the clinician opts to not save the segmentation to a specific profile or procedure, the process ends at step 118. As can be appreciated, even if the clinician chooses to not save the segmentation to a specific user profile or procedure, it is envisioned that the updated parameters of the neural network may be saved in order to be utilized during the next procedure. In embodiments, the updated parameters may not be saved, and the original, pre-trained neural network may be utilized for each procedure, unless the clinician selects a pre-saved profile.

Although generally described hereinabove, it is envisioned that the memory 22 may include any non-transitory computer-readable storage media for storing data and/or software including instructions that are executable by the processor 20 and which control the operation of the workstation 12. In an embodiment, the memory 22 may include one or more storage devices such as solid-state storage devices, e.g., flash memory chips. Alternatively, or in addition to the one or more solid-state storage devices, the memory 22 may include one or more mass storage devices connected to the processor 20 through a mass storage controller (not shown) and a communications bus (not shown).

Although the description of the computer-readable media contained herein refers to solid state storage, it should be appreciated by those skilled in the art that computer-readable storage media can be any available media that can be accessed by the processor 20. That is, computer readable storage media may include non-transitory, volatile and non-volatile, removable and non-removable media implemented in any method or technology for storage of information such as computer-readable instructions, data structures, program modules or other data. For example, computer-readable storage media may include RAM, ROM, EPROM, EEPROM, flash memory or other solid-state memory technology, CD-ROM, DVD, Blu-Ray or other optical storage, magnetic cassettes, magnetic tape, magnetic disk storage or other magnetic storage devices, or any other medium which may be used to store the desired information, and which may be accessed by the workstation 12.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of embodiments. Those skilled in the art will envision other modifications within the scope and spirit of the claims appended hereto.

What is claimed is:

1. A system, comprising:
a processor; and
a memory, the memory storing a neural network, which when executed by the processor:
generating an automatic segmentation of structures in computed tomography (CT) images of an anatomical structure;
receives an indication of errors within the automatic segmentation;
performs updates to the parameters of the neural network based upon the indication of errors; and
updates the segmentation based upon the updates to the parameters of the neural network.

2. The system according to claim 1, wherein the CT images of an anatomical structure are CT images of a lung.

3. The system according to claim 1, wherein the indication of errors within the automatic segmentation are portions of the anatomical structure which should be included in the automatic segmentation.

4. The system according to claim 1, wherein the indication of errors within the automatic segmentation are portions of the anatomical structure which should not be included in the automatic segmentation.

5. The system according to claim 1, wherein the updates to the automatic segmentation are non-local.

6. The system according to claim 1, wherein performing updates to the parameters of the neural network includes performing updates to only a portion of the parameters of the neural network.

7. The system according to claim 1, wherein when the processor executes the neural network, the neural network identifies a type of surgical procedure being performed.

8. The system according to claim 7, wherein the type of surgical procedure being performed is selected from the group consisting of a biopsy of a lesion, a wedge resection of the lungs, a lobectomy of the lungs, a segmentectomy of the lungs, and a pneumonectomy of the lungs.

9. The system according to claim 7, further including a display associated with the processor and the memory, wherein the neural network, when executed by the processor, displays the automatic segmentation in a user interface.

10. A method, comprising:
acquiring image data of an anatomical structure;
acquiring information on an area of interest located within image data of the anatomical structure;
generating an automatic segmentation of the area of interest from the image data using a neural network;
receiving information of errors within the automatic segmentation;
performing updates to the parameters of the neural network based upon the errors within the automatic segmentation; and
performing updates to the automatic segmentation based upon the updates to the parameters of the neural network.

11. The method according to claim 10, wherein acquiring image data includes acquiring computed tomography (CT) image data of the anatomical structure.

12. The method according to claim 10, wherein receiving information of errors within the automatic segmentation includes receiving information of portions of the anatomical structure which should not be included in the automatic segmentation.

13. The method according to claim 10, wherein receiving information of errors within the automatic segmentation includes receiving information of portions of the anatomical structure which should be included in the automatic segmentation.

14. The method according to claim 10, wherein performing updates to the parameters of the neural network includes performing updates to only a portion of the parameters of the neural network.

15. A method, comprising:
acquiring computed tomography (CT) image data of an anatomical structure;
generating an automatic segmentation of an area of interest from the CT image data using a neural network;
receiving information of errors within the automatic segmentation;
performing updates to a portion of the parameters of the neural network based upon the errors within the automatic segmentation;
performing updates to the segmentation based upon the updates to the parameters of the neural network;
receiving information of further errors within the updated segmentation;
performing further updates to a portion of the updates to the parameters of the neural network based upon the further errors within the updated segmentation; and
performing further updates to the updates to the segmentation based upon the further updates to the parameters of the neural network.

16. The method according to claim 15, wherein acquiring CT image data of an anatomical structure includes acquiring CT image data of the lungs.

17. The method according to claim 15, wherein receiving information of errors within the automatic segmentation includes receiving information of portions of the anatomical structure which should not be included in the automatic segmentation.

18. The method according to claim 15, wherein receiving information of errors within the automatic segmentation includes receiving information of portions of the anatomical structure which should be included in the automatic segmentation.

19. The method according to claim 15, further comprising displaying the automatic segmentation on a user interface of a display.

20. The method according to claim 15, further including receiving information of a type of surgical procedure being performed and performing update to the parameters of the neural network based upon the type of surgical procedure being performed.
